(19) United States
(12) Patent Application Publication
(10) Pub. No.: US 2024/0303570 A1
(43) Pub. Date: Sep. 12, 2024

(54) COMPUTING DEVICE, AND COMPUTING METHOD

(71) Applicant: Hitachi, Ltd., Tokyo (JP)

(72) Inventors: Avais AHMAD, Tokyo (JP); Shinichi HAYASHI, Tokyo (JP); Kaori NAKANO, Tokyo (JP)

(73) Assignee: Hitachi, Ltd., Tokyo (JP)

(21) Appl. No.: 18/452,835

(22) Filed: Aug. 21, 2023

(30) Foreign Application Priority Data
Mar. 6, 2023 (JP) 2023-033763

(51) Int. Cl. G06Q 10/0631

(52) U.S. Cl. CPC G06Q 10/06316

(57) ABSTRACT

A computing device includes a storage unit storing a job list, and a computing unit that performs a computation related to an instance capable of executing burst processing by consuming credits. The job list is a list of batch jobs. The batch jobs include a plurality of combinations of a time frame and data regarding a size of a job, the time frame being set as a combination of a time point at which execution of the job can be started and a time point at which the job should have been completed. The burst processing of the job is at a speed exceeding a baseline but not exceeding a maximum speed, the baseline being a processing speed of the job that can always be attained. The computing unit determines whether or not the job can be completed within the time frame, for the batch jobs in the job list.

### BACKGROUND OF THE INVENTION

### 1. Field of the Invention

The present invention relates to a computing device and a computing method.

### 2. Description of the Related Art

Online pay-by-the-hour rental services of computer resources are widely used. As the processing capacity of a computer resource is higher, a higher usage fee is charged. Hence, there is a need for selection of the minimum necessary computer resource. U.S Patent Application Publication No. 2021/0398176 discloses a burstable instance recommendation device that includes a processor and that provides information regarding a burstable instance provided by a public cloud, the burstable instance being a candidate to which a predetermined in-use instance is migrated. In the burstable instance recommendation device, the processor identifies a first candidate burstable instance that is provided by the public cloud and to which the in-use instance can be migrated, on the basis of performance time series data regarding the in-use instance, and calculates high-load-performance time series data regarding the identified first candidate burstable instance in which a load is estimated to be higher than that of the performance time series data, thereby calculating a penalty in the case of the high-load-performance time series data and recognizably displaying the cost for the first candidate burstable instance and the penalty.

### SUMMARY OF THE INVENTION

According to the invention described in U.S Patent Application Publication No. 2021/0398176, it cannot be determined whether an instance is suitable for specific batch jobs.

A computing device according to a first aspect of the present invention includes a storage unit that stores a job list and a computing unit that performs a computation related to an instance capable of executing burst processing by consuming credits. The job list is a list of batch jobs. The batch jobs include a plurality of combinations of a time frame and data regarding a size of a job, the time frame being set as a combination of a time point at which execution of the job can be started and a time point at which the job should have been completed. The burst processing is processing of the job at a speed exceeding a baseline but not exceeding a maximum speed, the baseline being a processing speed of the job that can always be attained. The computing unit determines whether or not the job can be completed within the time frame, for the batch jobs in the job list.

A computing method according to a second aspect of the present invention is a computing method executed by a computing device including a storage unit that stores a job list and a computing unit that performs a computation related to an instance capable of executing burst processing by consuming credits. The job list is a list of batch jobs. The batch jobs include a plurality of combinations of a time frame and data regarding a size of a job, the time frame being set as a combination of a time point at which execution of the job can be started and a time point at which the job should have been completed. The burst processing is processing of the job at a speed exceeding a baseline but not exceeding a maximum speed, the baseline being a processing speed of the job that can always be attained. The computing method includes determining whether or not the job can be completed within the time frame, for the batch jobs in the job list.

According to the present invention, it is possible to determine whether an instance is suitable for particular batch jobs.

### BRIEF DESCRIPTION OF THE DRAWINGS

FIG. 1 is an overall configuration diagram of a batch processing system;

FIG. 2 is a hardware configuration diagram of a general-purpose computer;

FIG. 3 is a diagram illustrating an example of an instance list and a job list;

FIG. 4 is a diagram illustrating an example of a resource list and a simulation result;

FIG. 5 is a diagram for explaining an increase and decrease in credits and a communication speed;

FIG. 6 is a diagram illustrating an example of a simulation result visualization diagram;

FIG. 7 is a flowchart illustrating processing executed by a computing unit;

FIG. 8 is a flowchart illustrating processing executed by the computing unit;

FIG. 9 is a diagram illustrating an example of an instance list update screen;

FIG. 10 is a diagram illustrating an example of a job list update screen; and

FIG. 11 is a diagram illustrating an example of a screen output by the visualization unit.

### DESCRIPTION OF THE PREFERRED EMBODIMENT

### First Embodiment

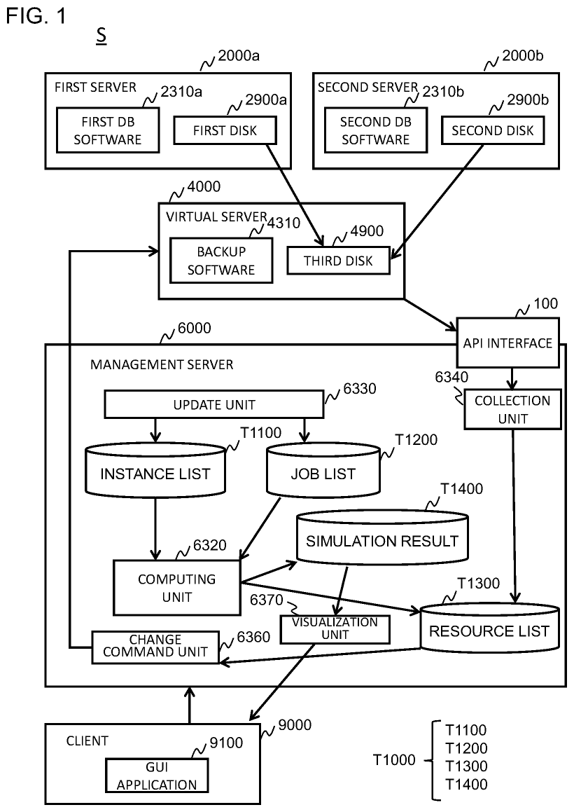

A management server according to a first embodiment, which is a computing device according to the present invention, will be described below with reference to FIGS. 1 to 11.

FIG. 1 is an overall configuration diagram of a batch processing system S including the management server. The batch processing system S includes a first server 2000a, a second server 2000b, a virtual server 4000, a management server 6000, and a client 9000. Hereinafter, a person who uses the batch processing system S is referred to as a “user.” For example, the use of the batch processing system S includes changing the settings of the batch processing system S and checking the operation of the batch processing system S. The number of users may be one or more. The users may be different persons or may always be the same person depending on the situation.

The first server 2000a includes a first database (DB) software 2310a for handling databases and a first disk 2900a. The second server 2000b includes a second DB software 2310b for handling databases and a second disk 2900b. Pieces of data stored in the first disk 2900a and the second disk 2900b are copied to a third disk 4900 by a batch job. This batch job may be executed by any of the first DB software 2310, the second DB software 2310b, and a backup software 4310.

The virtual server 4000 is a virtual machine and includes the backup software 4310 and the third disk 4900. The virtual server 4000 is any one of instances having different performance. In the present embodiment, an optimum instance for the virtual server 4000 is calculated. In the present embodiment, a data transfer speed that can be attained differs between instances. In the present embodiment, for the sake of simplicity of description, it is assumed that the data transfer speeds of the first disk 2900a and the second disk 2900b are sufficiently high and that the data transfer speed of the virtual server 4000 becomes a bottleneck.

The management server 6000 includes an application programming interface (API) interface 100, a computing unit 6320, an update unit 6330, a collection unit 6340, a change command unit 6360, and a visualization unit 6370. Various types of data T1000 are stored in a storage device included in the management server 6000. The various types of data T1000 include an instance list T1100, a job list T1200, a resource list T1300, and a simulation result T1400. The API interface 100 is software that allows software components to share data by communicating with each other. The collection unit 6340 acquires data regarding an instance currently used by the virtual server 4000, via the API interface 100, and writes the data to the resource list T1300.

The update unit 6330 updates the instance list T1100 and the job list T1200 on the basis of input made by a user. The computing unit 6320 performs computations, which will be described later, on the basis of the instance list T1100 and the job list T1200, and updates the simulation result T1400 and the resource list T1300. The change command unit 6360 reads the resource list T1300 and changes the instance of the virtual server 4000 as necessary. The visualization unit 6370 visualizes the simulation result T1400 and presents it to the client 9000.

The client 9000 is a computer used by the user. The client 9000 includes a graphics processing unit (GUI) application 9100 that communicates with the management server 6000 and presents a GUI screen, which will be described later, to the user. Note that the user may access the update unit 6330 of the management server 6000 via the client 9000.

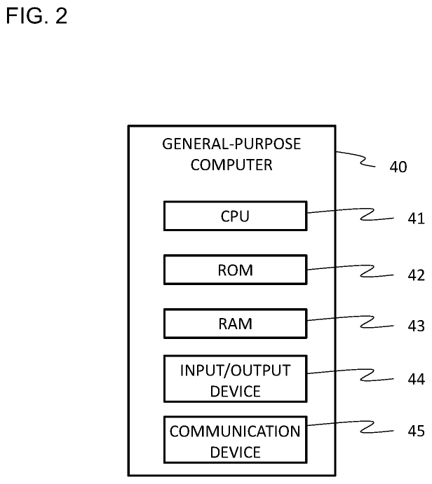

FIG. 2 is a hardware configuration diagram of a general-purpose computer 40 having hardware common to the first server 2000a, the second server 2000b, the management server 6000, and the client 9000. Note that the virtual server 4000 has, as virtual hardware, a configuration similar to that of the general-purpose computer 40, but does not have a physical configuration. An unillustrated hardware device that implements the virtual server 4000 has a configuration similar to that of the general-purpose computer 40. Note that the virtual server 4000 may be implemented by any one of the first server 2000a, the second server 2000b, and the management server 6000. The first server 2000a, the second server 2000b, the management server 6000, and the client 9000 do not necessarily have the same hardware configuration, and may further include hardware that the general-purpose computer 40 does not have.

The general-purpose computer 40 includes a central processing unit (CPU) 41, a read-only memory (ROM) 42 as a read-only storage device, a random access memory (RAM) 43 as a readable/writable storage device, an input/output device 44 as a user interface, a communication device 45, and a storage device 46. The CPU 41 performs various computations by loading, in the RAM 43, programs stored in the ROM 42 and executing the programs. The general-purpose computer 40 may be implemented by a field programmable gate array (FPGA) , which is a rewritable logic circuit, or an application specific integrated circuit (ASIC), which is an integrated circuit for specific use, instead of the combination of the CPU 41, the ROM 42, and the RAM 43. Also, instead of the combination of the CPU 41, the ROM 42, and the RAM 43, the general-purpose computer 40 may be implemented by a different combination of compositions, such as a combination of the CPU 41, the ROM 42, the RAM 43, and the FPGA.

The input/output device 44 includes a keyboard, a mouse, a liquid crystal display, and the like. Note that, instead of the input/output device 44, the general-purpose computer 40 may include a communication port to which a keyboard, a mouse, and a liquid crystal display can be connected. A person uses the input/output device 44 to exchange information with the general-purpose computer 40. However, the input/output device 44 is not an essential component. In particular, the first server 2000a, the second server 2000b, and the management server 6000 do not necessarily include the input/output device 44. The communication device 45 is, for example, a network interface card and performs communication with other devices. Any communication protocol may be used by the communication device 45. The storage device 46 is a non-volatile storage device.

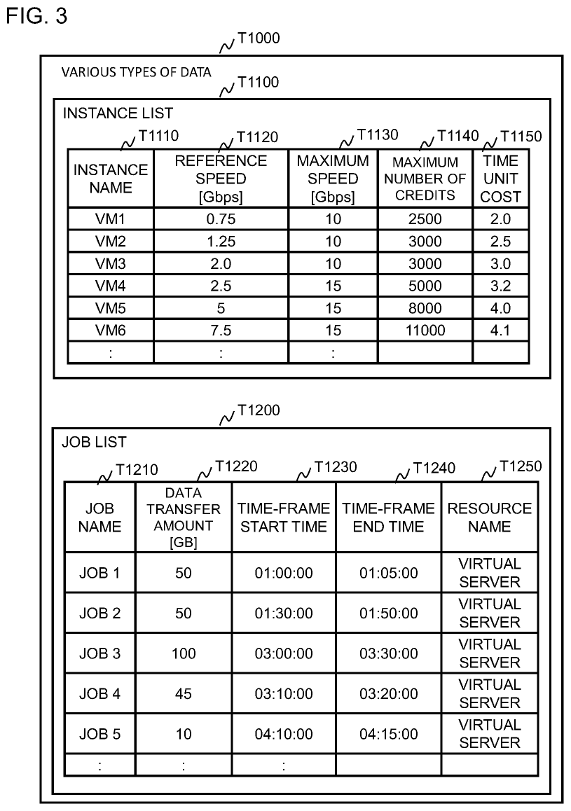

FIG. 3 is a diagram illustrating an example of the instance list T1100 and the job list T1200. The instance list T1100 and the job list T1200 may be created in advance, may newly be created by the update unit 6330, or may be subjected to partial addition or deletion by the update unit 6330.

The instance list T1100 is a list of available instances. In the present embodiment, a data transfer speed that can be attained differs between instances. In the present embodiment, a transfer speed, a data transfer speed, a processing speed, and throughput have the same meaning. Hereinafter, the transfer speed is also referred to as a “speed” simply. The instance list T1100 includes an instance name T1110, a reference speed T1120, a maximum speed T1130, a maximum number of credits T1140, and a time unit cost T1150 of each instance. In the present embodiment, the instances are sorted by cost, and the instance in the top row has the lowest cost. The instance name T1110 is a name or identifier of an instance. In the present embodiment, for convenience of explanation, the instance name T1110 is represented by a combination of “VM” and a number. As will be described later, as the number is higher, the performance and cost are higher.

The reference speed T1120 is a data transfer speed that can always be attained by the instance, and is also called a “baseline.” The maximum speed T1130 is the maximum speed that can be attained by the instance. The maximum number of credits T1140 is the maximum number of credits that the instance can hold. The credits will be described later. The time unit cost T1150 is the cost of using the instance. The instances have a positive correlation between the cost and the performance. That is, as the time unit cost T1150 is higher, the reference speed T1120, the maximum speed T1130, and the maximum number of credits T1140 tend to be larger.

The job list T1200 is a list of jobs that the batch processing system S should execute. The job list T1200 includes a job name T1210, a data transfer amount T1220, a time-frame start time T1230, a time-frame end time T1240, and a resource name T1250. The job name T1210 is a name or identifier of a job. In the present embodiment, the job name T1210 is represented by a combination of “job” and a number for convenience of explanation. Unlike the instance name T1110, the magnitude of the number in the job name T1210 has no special meaning. The data transfer amount T1220 is the total amount of data to be transferred in the job.

The time-frame start time T1230 is a time point at which the job starts. Time-frame end time T1240 is a time point at which the job should have been completed. The job is not allowed to start before the time-frame start time T1230 and to run beyond the time-frame end time T1240. The resource name T1250 is an identifier of a resource that executes the job. In the job list T1200, which instance the resource is to use is not described, and the computing unit 6320 can calculate the optimum instance as described later. Note that, in the present embodiment, a case where each resource changes its instance in the middle of the job is not assumed.

In the example illustrated in FIG. 3, a job whose name is “job 1” in the job name T1210 has a time frame of 1:00 to 1:05, and data of 50 GB is transferred to the virtual server 4000 in this job. Note that, although only a “virtual server,” namely, the virtual server 4000 in FIG. 1, is described in the resource name T1250 in the example illustrated in FIG. 3, a job related to a virtual server which is not illustrated may also be described.

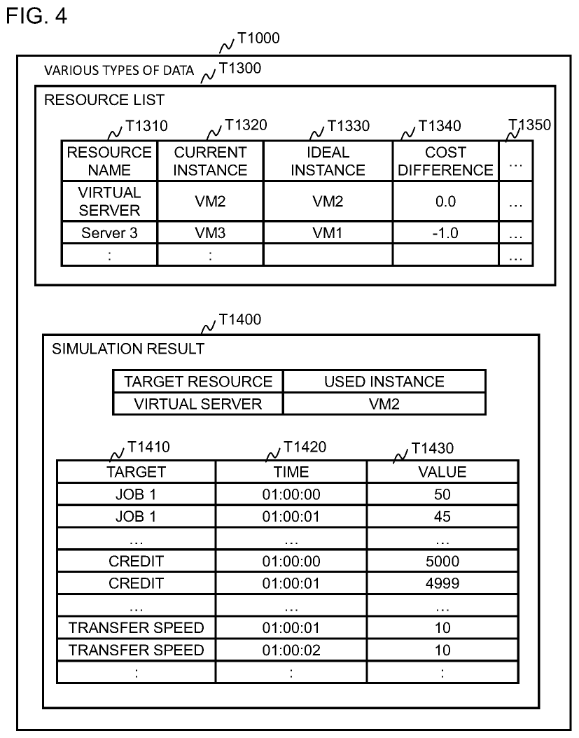

FIG. 4 is a diagram illustrating an example of the resource list T1300 and the simulation result T1400. The resource list T1300 is created by the collection unit 6340 and the computing unit 6320, and the simulation result T1400 is created by the computing unit 6320.

The resource list T1300 includes a resource name T1310, a current instance T1320, an ideal instance T1330, and a cost difference T1340. Note that the resource list T1300 may further include other resources that use a credit mechanism such as disks, as indicated by a reference sign “T1350.”

The resource name T1310 is a resource identifier and corresponds to the resource name T1250 in the job list T1200. The current instance T1320 is a current instance of the resource, and any one of the names in the instance name T1110 of the instance list T1100 is input to the current instance T1320. The ideal instance T1330 is an optimum instance for the resource and is calculated by the computing unit 6320. The cost difference T1340 is a difference of the cost between the current instance T1320 and the ideal instance T1330. Regarding the “virtual server” in the example illustrated in FIG. 4, the current instance T1320 and the ideal instance T1330 agree with each other, and the cost difference T1340 is thus zero. On the other hand, regarding “Server 3” in this example, the current instance T1320 is “VM3” while the ideal instance T1330 is “VM1,” and the cost difference T1340 is thus “−1.0.” Incidentally, “Server 3” is a virtual server not illustrated in FIG. 1.

The simulation result T1400 is a result of the computation performed by the computing unit 6320 on a combination of a specific resource and instance. More specifically, the simulation result T1400 includes the remaining amount of each job, the number of credits, and the transfer speed at each time point, which are obtained by the simulation. Although only one simulation result T1400 is illustrated in FIG. 4, different simulation results T1400 are generated depending on combinations of resources and instances.

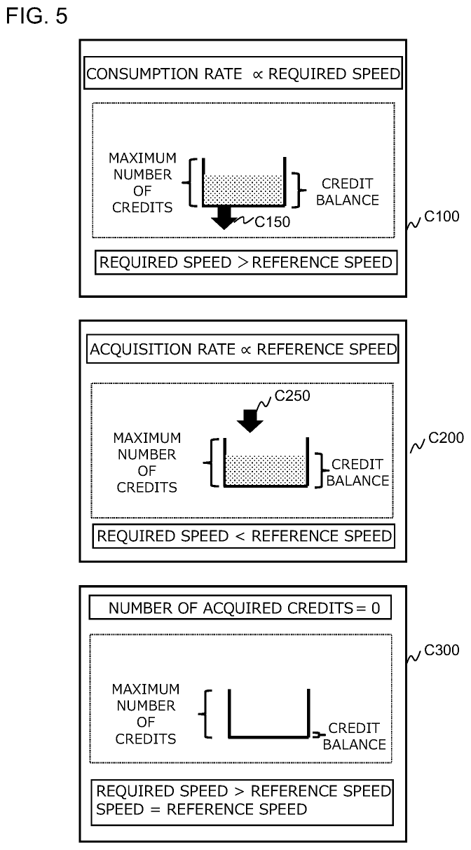

FIG. 5 is a diagram for explaining an increase and decrease in credits and a communication speed. In FIG. 5, the size of a container represents a maximum number of credits, and a liquid in the container represents a credit balance. The flow of liquid into the container represents an increase in credits, and the flow of liquid from the container represents consumption of credits. An upper part C100 of FIG. 5 indicates a case where a requested speed is higher than a reference speed and the credit balance is not zero. In this case, the number of credits is decreasing as indicated by an arrow C150, and the consumption rate is proportional to the requested speed. A maximum speed that can be attained by an instance is a value of the maximum speed T1130 in the instance list T1100. Hereinafter, the processing whose processing speed is faster than the reference speed is also called “burst processing.” In other words, the burst processing is performed under the condition that credits are consumed. The burst processing can also be referred to as processing of a job performed at a speed exceeding the baseline, which is the processing speed of the job that is always attained, but not exceeding the maximum speed.

A middle part C200 of FIG. 5 indicates a case where the requested speed is lower than the reference speed. In this case, the number of credits is increasing as indicated by an arrow C250, and the rate of increase is proportional to the reference speed. Once the number of credits reaches the maximum value, it stops increasing. Also, in this case, since the requested speed is lower than the reference speed, the instance can use the requested speed itself. A lower part C300 of FIG. 5 indicates a case where the requested speed is higher than the reference speed and the credit balance is zero. In this case, the speed is limited to the reference speed, and the number of the acquired credits becomes zero.

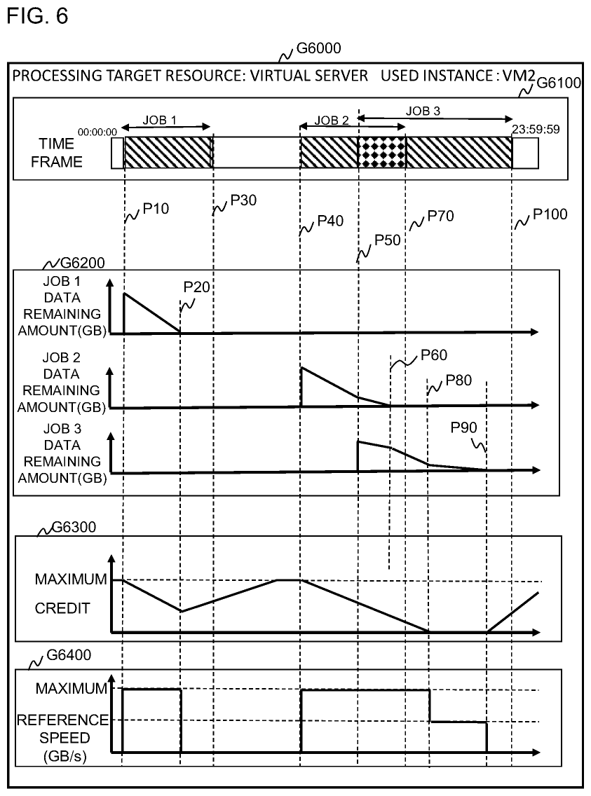

FIG. 6 is a diagram illustrating an example of a simulation result visualization diagram G6000 generated by the visualization unit 6370. The simulation result visualization diagram G6000 is generated on the basis of the simulation result T1400 generated by the computing unit 6320. As mentioned above, the simulation result is generated according to combinations of resources and instances. The example illustrated in FIG. 6 indicates a case where a processing target resource is the “virtual server” and the used instance is “VM2.”

The simulation result visualization diagram G6000 includes a time frame G6100, a job remaining amount G6200, a credit transition G6300, and a speed transition G6400. The time frame G6100, the job remaining amount G6200, the credit transition G6300, and the speed transition G6400 have the same time axis, and broken lines indicated by reference signs P10 to P100 each represent the same time point.

The time frame G6100 indicates, as a Gantt chart, a time frame regarding a job executed by the processing target resource described in the job list T1200. That is, the time frame G6100 is generated on the basis of the job list T1200 rather than the simulation result T1400. More specifically, a length of time from the time-frame start time T1230 to the time-frame end time T1240 is indicated by hatching, and the name of the job is written above the hatching.

The job remaining amount G6200 indicates a graph illustrating a chronological change in the data remaining amount of each job. The data remaining amount of each job at each time point is described in the simulation result T1400. Note that the data remaining amount of each job at a time point not described in the simulation result T1400 is assumed to be the same as a previous data remaining amount of a corresponding job described in the simulation result T1400 or to be zero. A scale of a vertical axis of each graph of the job remaining amount G6200 may be different among jobs or common to all jobs.

The credit transition G6300 is a time-series graph illustrating the transition of credits held by the processing target resource. The number of credits at each time point is described in the simulation result T1400. An upper limit is set on the number of credits that each resource can hold, and the number of credits does not exceed a predetermined maximum value. Also, a lower limit of the number of credits is zero.

The speed transition G6400 is a time-series graph illustrating the transition of the speed of the processing target resource. The speed at each time point is described in the simulation result T1400. As mentioned above, an upper limit of the speed and a reference value are set in advance to each instance. The speed of each resource in the present embodiment is set to zero, a reference value, or a maximum value.

A time point P10 is a time-frame start time of “job 1,” and the transfer is started at this time point. A time point P20 is a time point at which “job 1” has completed the transfer. Between the time point P10 and the time point P20, the credits are consumed, and the maximum speed is used. A time point P30 is a time-frame end time of “job 1.” The “Job 1” is ended before the time-frame end time. Since no job is executed between the time point P20 and a time point P40, the number of credits increases with the lapse of time and reaches the maximum value.

The time point P40 is a time-frame start time of “job 2,” and a time point P50 is a time-frame start time of “job 3.” The “Job 2” is started at the time point P40 and consumes credits to perform processing at the maximum speed, but is yet to be completed at the time point P50. At the time point P50, “job 3” is started, and the speed is evenly divided between the two jobs. Therefore, a slope of a straight line indicating the data remaining amount of “job 2” becomes gentle after the time point P50 in the job remaining amount G6200.

At a time point P60, “job 2” is completed, but “job 3” is not completed, so that the processing continues. Since “job 2” is completed at the time point P60, “job 3” no longer needs to share the speed with other jobs, and a slope of a straight line indicating the data remaining amount of “job 3” becomes steep after the time point P60 in the job remaining amount G6200. A time point P70 is a time-frame end time of “job 2,” and “job 2” is completed before the time point P70.

At a time point P80, the number of credits becomes zero, and the speed drops to the reference speed. Therefore, after the time point P80, the slope of the straight line indicating the data remaining amount of “job 3” becomes gentle in the job remaining amount G6200. At a time point P90, the data transfer of “job 3” ends. Since there is no job after the time point P90, the number of credits increases with the lapse of time. A time point P100 is a time-frame end time of “job 3,” and “job 3” is completed before the time point P100. The above is the description in FIG. 6.

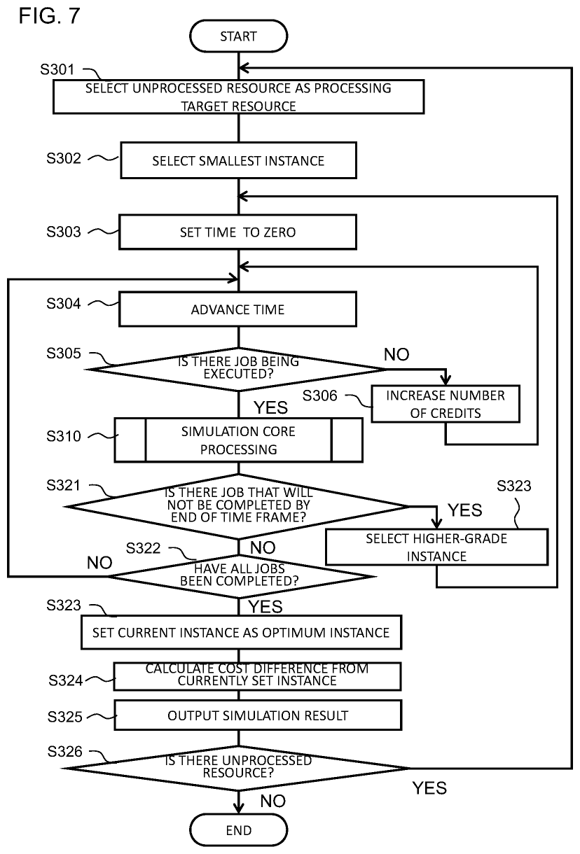

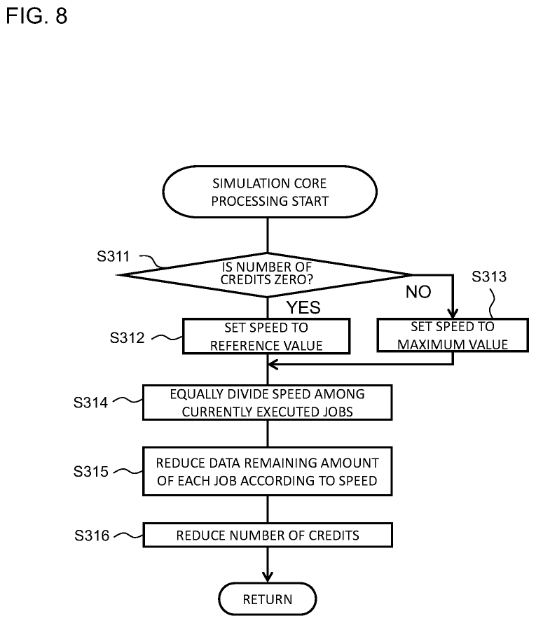

FIGS. 7 and 8 are flowcharts illustrating processing executed by the computing unit 6320. In step S301, the computing unit 6320 selects any one of the unprocessed resources as a processing target resource. In subsequent step S302, the computing unit 6320 selects the smallest instance as a provisional instance to be used by the processing target resource, and proceeds to step S303. For example, in the example illustrated in FIG. 3, “VM1” is selected.

In step S303, the computing unit 6320 sets the time to zero. Herein, the earliest time point is simply referred to as “zero” for the sake of convenience, and any time point may be set as long as it is before the earliest time point among the time points described in the time-frame start time T1230 of the job list T1200. Note that the number of credits at the time point of zero is a predetermined value such as zero or a maximum value.

In step S304, the computing unit 6320 advances the time by a predetermined length time, of for example, one second. Hereinbelow, this length of time is called a “unit time.” In subsequent step S305, the computing unit 6320 determines whether or not there is a job currently being executed. When determining that there is a job currently being executed, the computing unit 6320 proceeds to simulation core processing of step S310. On the other hand, when determining that there is no job currently being executed, the computing unit 6320 proceeds to step S306. The computing unit 6320 can determine whether or not there is a job currently being executed as follows. That is, the computing unit 6320 can make determination by extracting jobs whose time-frame start time is earlier than the current time, deleting completed jobs from the extracted jobs, and then determining whether or not there is a remaining job.

In step S306, the computing unit 6320 increases the number of credits held by the processing target resource and returns to step S304. The number of credits is increased to a predetermined value, for example, a value obtained by multiplying the reference speed of the processing target resource by a predetermined proportionality coefficient. The simulation core processing in step S310 will be described in detail with reference to FIG. 8.

In step S311, which is the first step of the simulation core processing, the computing unit 6320 determines whether or not the number of credits held by the processing target resource at the current time is zero. When determining that the number of credits is zero, the computing unit 6320 proceeds to step S312. On the other hand, the computing unit 6320 proceeds to step S313 when determining that the number of credits is not zero. In step S312, the computing unit 6320 sets the speed to the reference value and proceeds to step S314. In step S313, the computing unit 6320 sets the speed to the maximum value and proceeds to step S314.

In step S314, the computing unit 6320 equally divides the speed among jobs according to the number of the jobs being executed. For example, if the speed is set to 15 Gbps in step S312 or step S313 and there are three jobs currently being executed, the speed of each job is set to 5 Gbps. In subsequent step S315, the computing unit 6320 reduces the data remaining amount of each job according to the speed. More specifically, the value obtained by equally dividing the speed by the number of jobs in step S314 is multiplied by the unit time, which is the length of time to be advanced in step S304, to reduce the data remaining amount. For example, when the value obtained by equally dividing the speed by the number of jobs in step S314 is 5 Gbps and the unit time is one second, the data amount is reduced by 5 Gb.

In subsequent step S316, the computing unit 6320 decreases the number of credits and terminates the processing illustrated in FIG. 8. The number of credits may be decreased to a predetermined constant value or a value corresponding to the maximum speed. With reference to FIG. 7 again, the description of the processing is further given.

In step S321 executed after step S310, the computing unit 6320 determines whether or not there is a job that will not be completed by the end of the time frame. For example, in the example illustrated in FIG. 3, if “job 1” has not been completed at “01:05:01,” the determination in this step is affirmative. When the computing unit 6320 determines that all jobs will be completed by the end of the time frame, the computing unit 6320 proceeds to step S322. When the computing unit 6320 determines that there is a job that will not be completed by the end of the time frame, the computing unit 6320 proceeds to step S323. In step S323, the computing unit 6320 selects a higher-grade instance and then returns to step S303. With the use of a higher-grade instance, although the cost increases, at least either the reference speed or the maximum speed is improved, thereby increasing the possibility that the jobs will be completed in time.

In step S322, the computing unit 6320 determines whether or not all jobs executed by the processing target resource have been completed. Here, “all jobs” refers to not only jobs that have reached the start time of the time frame by the current time, but also all jobs that are executed by a resource whose name described in the resource name T1250 of the job list T1200 corresponds to the processing target resource. When the computing unit 6320 determines that all jobs have been completed, the computing unit 6320 proceeds to step S323. On the other hand, when determining that there is an uncompleted job, the computing unit 6320 returns to step S304.

In step S323, the computing unit 6320 sets the current instance as the optimum instance. This is because the current instance is the instance that allows all jobs to be completed by the ends of the time frames with the lowest cost. In subsequent step S324, the computing unit 6320 calculates the cost difference from the currently set instance. In subsequent step S325, the computing unit 6320 outputs the simulation result to the simulation result T1400. More specifically, the computing unit 6320 outputs the remaining amount of each job, the number of credits, and the speed at each time point. Note that, when making affirmative determination in step S321, the computing unit 6320 deletes the progress of the simulation and outputs only the simulation result obtained by using the optimum instance.

In subsequent step S326, the computing unit 6320 determines whether or not there is an unprocessed resource. When determining that there is an unprocessed resource, the computing unit 6320 returns to step S301. On the other hand, when the computing unit 6320 determines that there is no unprocessed resource, the processing illustrated in FIG. 7 is terminated.

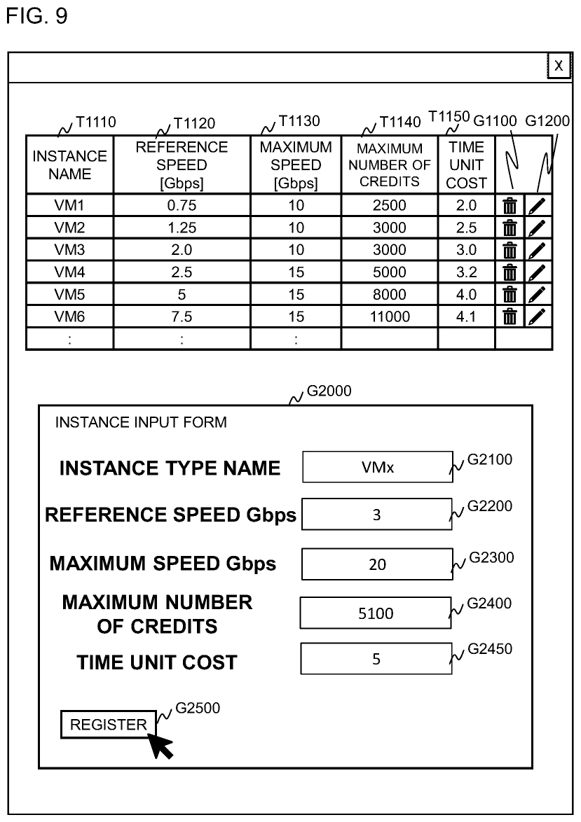

FIG. 9 is a diagram illustrating an example of an update screen for the instance list T1100. This screen is generated by the update unit 6330. The existing instance list T1100 is illustrated at an upper part of FIG. 9. However, delete buttons G1100 and correction buttons G1200 are arranged at the right end of the instance list T1100. When the user presses the delete button G1100 of any row, the data of this row is deleted. When the user presses the correction button G1200 of any row, the data of this row is entered into an instance input form G2000.

By using the instance input form G2000 illustrated at a lower part of FIG. 9, the user can register new instances and correct the existing instances. A reference sign G2100 represents an input field for the instance name T1110. A reference sign G2200 represents an input field for the reference speed T1120. A reference sign G2300 represents an input field for the maximum speed T1130. A reference sign G2400 represents an input field for the maximum number of credits T1140. A reference sign G2500 represents a registration button for adding or changing an instance. When the user presses the registration button G2500, the update unit 6330 updates the instance list T1100.

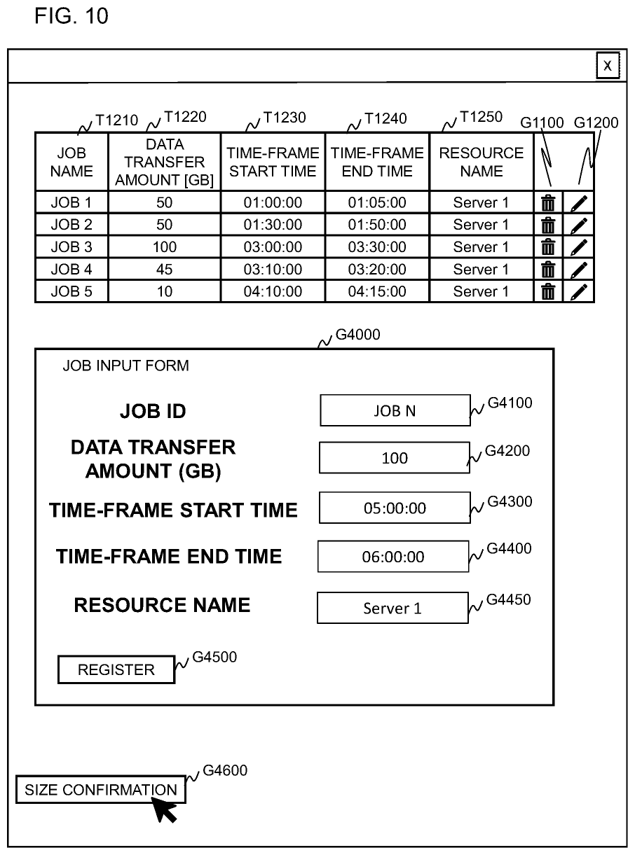

FIG. 10 is a diagram illustrating an example of an update screen for the job list T1200. This screen is generated by the update unit 6330. The existing job list T1200 is illustrated at an upper part of FIG. 10. However, the delete buttons G1100 and the correction buttons G1200 are arranged at the right end of the job list T1200. When the user presses the delete button G1100 of any row, the data of this row is deleted. When the user presses the correction button G1200 of any row, the data of this row is entered into a job input form G4000.

By using the job input form G4000 illustrated at a lower part of FIG. 10, the user can register new instances or correct the existing instances. A reference sign G4100 represents an input field for the job name T1210. A reference sign G4200 represents an input field for the data transfer amount T1220. A reference sign G4300 represents an input field for the time-frame start time T1230. A reference sign G4400 represents an input field for the time-frame end time T1240. A reference sign 4450 represents an input field for the resource name T1250. A reference sign G4500 represents a registration button for adding or changing jobs. When the user presses the registration button G4500, the update unit 6330 updates the job list T1200. A reference sign G4600 represents a button for confirming the optimum instance size. When the user presses this button, the computing unit 6320 is activated to generate the simulation result T1400. After that, the visualization unit 6370 is activated to display the simulation result T1400.

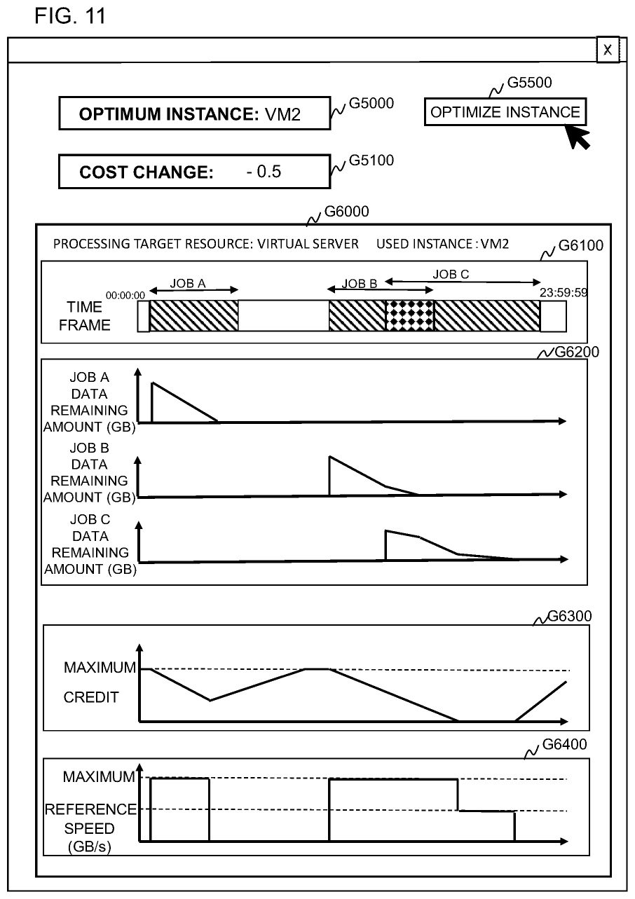

FIG. 11 is a diagram illustrating an example of a screen output by the visualization unit 6370. A reference sign G5000 represents an optimum instance calculated by the computing unit 6320, that is, the ideal instance T1330 in the resource list T1300. A reference sign G5100 represents the cost difference between the current instance and the optimum instance, that is, the cost difference T1340. A reference sign G5500 represents a button for optimizing the type of instance. When the user presses the button G5500, the change command unit 6360 refers to the resource list T1300 and changes the instance to the optimum instance. Since the simulation result visualization diagram G6000 illustrated in a lower part of FIG. 11 is similar to that in FIG. 6, the description thereof is omitted.

According to the first embodiment described above, the following effects are obtained.

(1) The management server 6000, which can also be referred to as a computing device, includes the RAM 43 as a storage unit that stores the job list T1200, and the computing unit 6320 that performs a computation related to an instance capable of executing burst processing by consuming credits. The job list T1200 is a list of batch jobs. The batch jobs include a plurality of combinations of the data transfer amount T1220 and a time frame that is set as a combination of the time-frame start time T1230 and the time-frame end time T1240. The burst processing is processing of jobs at a speed exceeding the baseline, which is the processing speed of the job that can always be attained, but not exceeding the maximum speed. The computing unit 6320 determines whether or not the job can be completed within the time frame, for the batch jobs described in the job list T1200. Therefore, the management server 6000 can determine whether or not an instance is suitable for specific batch jobs.

(2) The RAM 43 stores the instance list T1100. The instance list T1100 includes, for each instance, the reference speed T1120, which is the baseline, the maximum speed T1130, the maximum number of credits T1140, and the time unit cost T1150. The computing unit 6320 identifies an instance that allows the job to be completed within the time frame and that achieves the lowest cost, for all the batch jobs in the job list. Therefore, the management server 6000 can identify the optimum instance.

(3) The computing unit 6320 performs a simulation to calculate the remaining amount of the job and the credit balance at each time point in the batch job.

(4) The computing unit 6320 first selects an instance that achieves the lowest cost, to perform the simulation, and when at least one batch job fails to complete the job within the time frame, the computing unit 6320 selects an instance that achieves the second lowest cost, to perform the simulation.

(5) The job is a data transfer from the first disk 2900a or the second disk 2900b to the third disk 4900, and the difference between the baseline and the maximum speed is the difference in data transfer speed.

### Modification 1

In the embodiment described above, the job is data transfer. However, the job is not limited to data transfer, and can be any of various types of processing that use computer resources. For example, a job may be the execution of a computation. In this case, the difference in the number of computations per unit time is the difference between the baseline and the maximum speed. More specifically, the usage rate of the CPU that can be used by the job, the number of cores of the CPU, the number of physical CPUs, or the like is the difference between the baseline and the maximum speed.

### Modification 2

In the embodiment described above, the computing unit 6320 identifies an optimum instance for each resource. However, the computing unit 6320 may only determine whether or not the job can be completed within the time frame, for the batch jobs in the job list T1200, in a case of a combination of a certain resource and a certain instance. More specifically, only the processing from steps S303 to S322 in FIG. 7 may be executed in a state where the resource and the instance are specified in advance.

### Modification 3

In the embodiment described above, the computing unit 6320 identifies the optimum instance by sequentially selecting an instance such that the grade of the instance increases one by one (step S323 in FIG. 7). However, the computing unit 6320 does not necessarily need to sequentially select an instance such that the grade of the instance increases one by one. For example, the grade may increase by two each time, or may randomly increase by any number selected from among 1 to 5.

### Modification 4

The batch processing system S may be applied to a hybrid cloud, that is, a mixed configuration of a public cloud and a private cloud. In this case, the resource to be operated by the computing unit 6320 may be limited to a virtual machine in the public cloud. This is because a virtual machine in a private cloud that uses its own resource does not need to be restricted.

In the embodiment and the modifications described above, the configuration of the functional blocks is merely an example. Some functional configurations illustrated as separate functional blocks may be configured integrally, or a configuration illustrated as one functional block may be divided into two or more functions. Further, some of the functions of the respective functional blocks may be included in another functional block.

Although the program is stored in the ROM 42 in the embodiment and the modifications described above, the program may be stored in a non-volatile storage device. Alternatively, the general-purpose computer 40 may have an input/output interface which is not illustrated, and the program may be read from another device via a medium that can be used by the input/output interface and the general-purpose computer 40 when necessary. Here, the medium refers to, for example, a storage medium that can be attached to and detached from the input/output interface, a communication medium, i.e., a wired or wireless network or an optical network, or a carrier wave or digital signal that propagates through the network. Also, some or all of the functions implemented by the program may be implemented by a hardware circuit or an FPGA.

The embodiment and the modifications described above may be combined. Although the embodiment and the modifications have been described above in various way, the present invention is not limited to the details. Other aspects conceivable within the scope of the technical idea of the present invention are also included in the scope of the present invention.

What is claimed is:

1. A computing device comprising:
a storage unit that stores a job list; and
a computing unit that performs a computation related to an instance capable of executing burst processing by consuming credits, wherein
the job list is a list of batch jobs,
the batch jobs include a plurality of combinations of a time frame and data regarding a size of a job, the time frame being set as a combination of a time point at which execution of the job can be started and a time point at which the job should have been completed,
the burst processing is processing of the job at a speed exceeding a baseline but not exceeding a maximum speed, the baseline being a processing speed of the job that can always be attained, and
the computing unit determines whether or not the job can be completed within the time frame, for the batch jobs in the job list.

2. The computing device according to claim 1, wherein
the storage unit further stores an instance list,
the instance list includes, for each instance, the baseline, the maximum speed, a maximum balance of the credits, and a cost required to use a corresponding instance, and
the computing unit identifies an instance that allows the job to be completed within the time frame and that achieves the lowest cost, for all the batch jobs in the job list.

3. The computing device according to claim 2, wherein
the computing unit performs a simulation to calculate a remaining amount of the job and a balance of the credits at each time point in a corresponding batch job.

4. The computing device according to claim 3, wherein
the computing unit first selects an instance that achieves the lowest cost, to perform the simulation, and when at least one of the batch jobs fails to complete the job within the time frame, the computing unit selects an instance that achieves the second lowest cost, to perform the simulation.

5. The computing device according to claim 1, wherein
the job is a transfer of data from a first storage device to a second storage device, and a difference between the baseline and the maximum speed is a difference in data transfer speed.

6. The computing device according to claim 1, wherein
the job is execution of computations, and a difference between the baseline and the maximum speed is a difference in the number of computations per unit time.

7. The computing device according to claim 2, further comprising:
a visualization unit that creates a visualization diagram that visualizes a result of a simulation performed by the computing unit.

8. The computing device according to claim 2, wherein
the computing unit further calculates a cost difference between the instance set in advance and the instance that is identified by the computing unit and that achieves the lowest cost.

9. The computing device according to claim 2, further comprising:
a change command unit that changes an instance of a virtual machine related to the batch jobs to the instance that is identified by the computing unit and that achieves the lowest cost.

10. A computing method executed by a computing device including a storage unit that stores a job list and a computing unit that performs a computation related to an instance capable of executing burst processing by consuming credits,
the job list being a list of batch jobs,
the batch jobs including a plurality of combinations of a time frame and data regarding a size of a job, the time frame being set as a combination of a time point at which execution of the job can be started and a time point at which the job should have been completed,
the burst processing being processing of the job at a speed exceeding a baseline but not exceeding a maximum speed, the baseline being a processing speed of the job that can always be attained,
the computing method comprising:
determining whether or not the job can be completed within the time frame, for the batch jobs in the job list.
